(19) United States
(12) Patent Application Publication
(10) Pub. No.: US 2005/0165726 A1
(43) Pub. Date: Jul. 28, 2005

(54) Packaged, organized collections of digital information, and mechanisms and methods for navigating and sharing the collection

(75) Inventors: Leonard M. Kawell JR., Concord, MA (US); Mary Ellen Heinen, Concord, MA (US); Patrick J. McGowan, Princeton, MA (US); William Filler, Belmont, MA (US); Steve Magoun, Cambridge, MA (US)

Correspondence Address: WILMER CUTLER PICKERING HALE AND DORR LLP, 60 STATE STREET, BOSTON, MA, 02109, US

(73) Assignee: Pepper Computer, Inc., Lexington, MA (US)

(21) Appl. No.: 10/978,840

(22) Filed: Nov. 1, 2004

Related U.S. Application Data
(60) Provisional application No. 60/515,786, filed on Oct. 30, 2003.
(60) Provisional application No. 60/515,753, filed on Oct. 30, 2003.

(51) Int. Cl. G06F 17/30

(52) U.S. Cl. 707/1

(57) ABSTRACT

The systems and methods are used to create collections of digital information and to share that information. The systems can obtain and use applications and their data, referred to as packages, that can allow users to create multimedia content (including photographs, text, video, and music) for sharing and collaborating.

### CROSS-REFERENCE TO RELATED APPLICATIONS

This application claims priority to provisional application Ser. No. 60/515,786, filed Oct. 30, 2003, and No. 60/515,753, filed Oct. 30, 2003, each of which is incorporated herein by reference.

### BACKGROUND

In many group, social, or collaborative environments, participants are loosely or tightly organized into groups that have a common mission or interest, and possibly shared responsibility for a project. In these groups, a participant's enjoyment or productivity depends in part on the ability to interact with other participants to exchange information.

Email tools are important communication tools. While enabling collaborators to attach documents and store them, the communication function is essentially separate from the creation of commonly used documents and resources. In other words, while collaborators can email each other attachments, and maintain a thread of discussion, email is a serial communication tool, with each participant reading and responding to a chain of messages.

Chat rooms are interactive discussion windows where a number of users on separate computers can communicate by text entry in a shared text window that is displayed on each of the user's computers. Chat rooms provide for interactive discussion, but do not provide an effective mechanism to store and access shared files or documents.

When objects such as files or documents are shared, it can be useful to synchronize objects between object stores on two different computing devices, e.g., two mobile devices, two desktop or portable computers, or a mobile device and a desktop or portable computer. For example, one of the computing devices may be, or include, a mobile device such as a personal digital assistant (PDA). The mobile device may be, or include, a pager, a hand held device, or a palm size device, which comfortably fits within the hand. Generally, the mobile device includes a communication interface used to communicate with the desktop computer.

A mobile device can be used in conjunction with the desktop computer. For example, the user of the mobile device may also have access to, and use, a desktop computer at work or at home or both. The user may run the same types of applications on both the desktop computer and on the mobile device. It is advantageous for mobile devices to be designed to be coupled to the desktop computer to exchange and share information with the desktop computer.

Personal information managers (PIMs) are commonly found in mobile devices. PIMs typically include applications which enable the user of the mobile device to better manage scheduling and communications, and other such tasks. Some commonly available PIMs include scheduling and calendar programs, task lists, address books, and email programs. In addition to PIMs, mobile devices may also run different types of applications, such as word processors and spread sheets.

In some systems, a user can make changes to the PIMs and other applications both on the mobile device and at the desktop. Therefore, it is advantageous for data stores associated with the PIMs and applications on both the mobile device and the desktop to contain the most up-to-date information, regardless of whether recent changes to the PIMs and other applications have been made on the mobile device or on the desktop computer. The process of coupling the mobile device with the desktop computer, and integrating the information stored by the PIMs on the mobile device and the desktop computer such that the two contain the same updated information is an example of synchronization.

### SUMMARY

The systems and methods described herein are useful for creating collections of digital information and for sharing that information. The systems can obtain and use applications and their data, referred to as packages, that can allow users to create multimedia content (including photographs, text, video, and music) for sharing and collaborating. A package is divided into pages, preferably with an intermediate unit of pages called a section. The user can have a keeper program operates on a computer to manage common functions across packages. The keeper can include an instant messaging client, web browser, music library, video library, email, address book, and Internet radio. Pages can optionally be obtained individually via download for further use, allowing the user to pay only for what he or she needs, without the need for a large and complicated program to create pages.

The systems and methods also include collaboration methods, preferably using instant messaging, designed to simplify such collaboration. A user can share one or more pages with others, and the user's system maintains information about who received what information and when. Updates can then be provided to the recipients. The system helps promote the ability of a sender to send a package (or pages of a package) and the recipient to add further content to send back.

The systems and methods also include the use of a web server that can be operated by Internet service providers to act as a locker for storing information for backup.

Other features and advantages will become apparent from the following detailed description and drawings.

### BRIEF DESCRIPTION OF THE DRAWINGS

FIGS. 1-3 are block diagrams of a package and its parts.

FIGS. 4-6 are block diagrams of templates and pages in a package illustrating an embodiment.

FIG. 7 is a flowchart illustrating the process by which the data is transformed.

FIG. 8 is a block diagram of an exemplary journal page.

FIG. 9 is a block diagram of a navigational bar.

FIG. 10 is a block diagram showing communications through a server.

FIG. 11 is flow chart showing sending a package by instant messaging.

FIG. 12 is an example of a dialog box with package, recipient, and date stamp information.

FIG. 13 is a block diagram of the process of converting pages to a JAR file.

FIG. 14 is a block diagram illustrating communications between users by email.

### DETAILED DESCRIPTION

The systems and methods described here relate to the creation and use of certain applications and their data, referred to as packages, communications methods, and sharing methods for users to share data and packages. The systems and methods provide for a versatile, robust application to be used primarily in a mobile device, such as a personal digital assistant (PDA), small laptop, or tablet-style computer to create and share files for the application.

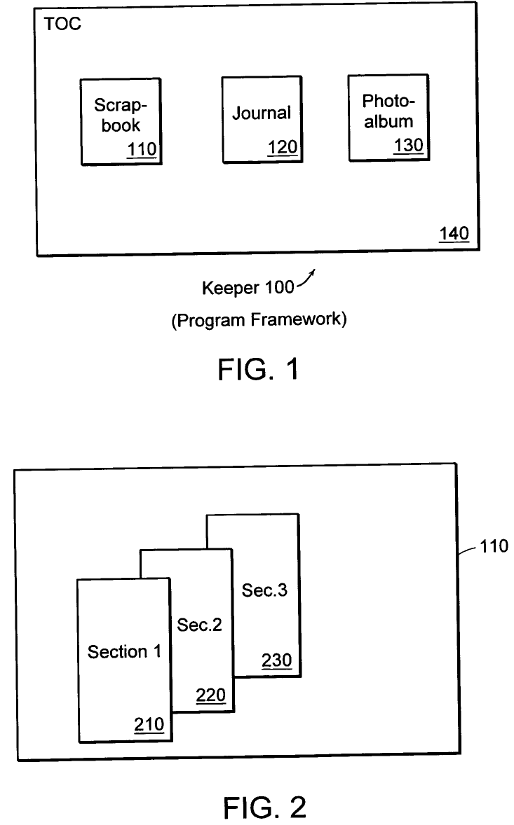

FIG. 1 shows a block diagram of a system that has a keeper program 100 running on a computing device, such as a laptop computer, tablet-style computer, or other hand-held computing device. The keeper 100 can be installed in a client computer or mobile device by downloading a directly-executable program (.exe) from a web server, with the necessary components provided into directories for later use. The device should have at least a display screen and keys, and can include other means for entering data, such as a scroll, D-pad, stylus, or touch screen. The computer can have other features as described in the incorporated application No. 60/515,753.

The keeper program is integrated client software, preferably written in the Java programming language or some other portable language. The keeper manages a number of modular components, referred to here as packages, shown here in a table of contents (TOC) 140. A package can be implemented as a plug-in, single purpose application program, and can be used to create and share organized collections of content. While there can be many kinds of packages, the keeper 100 represented in FIG. 1 is shown with three exemplary packages: a scrapbook package 110, a journal package 120, and a photo album package 130. These packages can be used to create multimedia content. Both the keeper 100 and the packages 110, 120, and 130 shown in FIG. 1 are implemented as software programs. Other packages that can be provided include a greeting card package for creating and sending greeting cards; and a music package for downloading and organizing music, including the ability to create electronic albums with user-created album covers.

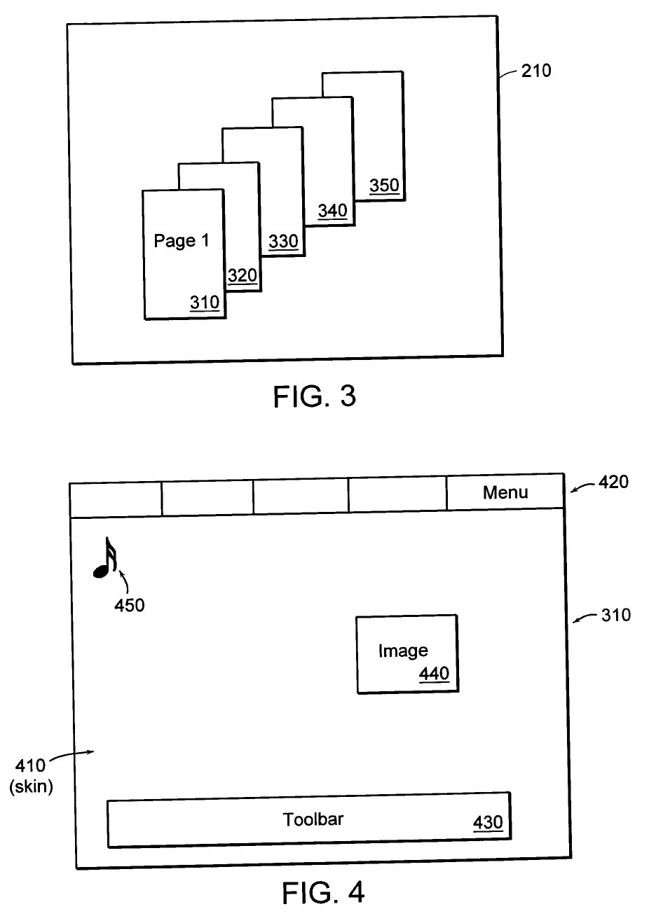

As shown in FIGS. 2 and 3, a package 110 can have multiple sections 210, 220, and 230; and each of these sections can have multiple, separate pages 310-350. The pages in these packages can include text, graphics, music, video, or other multimedia, and are designed for sharing with others and for collaboration, or they can be for personal use. The sections can divide into groups of pages, such as a section for a vacation or a holiday season.

A package can include three sets of files: program files, templates, and user/data files. Program files have code that executes the program. These packages, without added content, can be small; in the case of a journal, they can be little more than empty Java classes whose implementation is handled by the keeper.

The templates define both the rules for transforming data into a form for presentation and the elements of style within that presentation. As indicated below, the presentation can be separated from the multimedia content, so one can change without changing the other.

The user/data files are in a markup language, and preferably are Extensible Markup Language (XML) files. Every page in the system or in the program can have a separate file. Those files can include embedded objects such as an image imbedded in a scrapbook.

These examples of packages share some common features and have a few differences. In each case, they can be multimedia and used for recording thoughts and memories. A photo album would typically be for multiple party use, while a journal might be private or it could be shared with a group of close friends. The use of sections and pages are thus analogous to versions of these applications in document form. For example, a physical photo album might be divided into sections for vacations, graduation, or other events, and within a section, there could be multiple pages of photos and other items, such as ticket stubs. Similarly, the packages can maintain similar types of items electronically, with the further ability to provide music and video.

The keeper represents a container for the packages. It allows users to switch between the packages so that they can run multiple packages at the same time and switch between them. Most of the high level package code is maintained in the keeper, and each package inherits the code from the keeper and extends it with its own package code. For example, showing pages, creating pages, displaying pages, and navigating through pages are all common features that are maintained in the system. The system can also include the ability to play a song and show buttons on the tool bar such as stop, play, change volume, etc. A music player package can be built on top of the framework such that a user can import songs and organize songs into the user's own library.

FIG. 4 illustrates an embodiment of the invention depicting one page 310 of a package. Page 310 can have several interactive elements including a user-defined skin 410, user-selectable controls, such as a menu bar 420 and a tool bar 430, and content such as an image 440 and a multi-media audio 450. Page elements 410-450 are highly scalable and customizable, meaning that the user can customize page 310 according to the user's specifications through a graphical user interface (GUI) or a command-driven interface. As discussed below, a user can change the skin 410 to change the background image, the imagery around the page, the page layout, and the page images to tailor the layout and the overall appearance of the page.

In FIG. 4, a user has started with a blank page and has imported an image 440, scaled it, and placed it on the page at a location indicated by the user. In addition, the user has imported audio 450 to be played. In one embodiment, the audio can be music played by a music player, with the music being in one of a number of audio formats, such as MP3. In the case of a photo album, for example, photos relating to an event, such as a prom, could be combined with music from a class song, or graduation photos can be combined with processional music. Java objects are created when the user imports pictures and music into a page.

Menu bar 420 and tool bar 430 can each be page-specific, such that other pages can have different tool bars and menu bars which gets displayed on their respective pages. In addition, within the scope of the present embodiment, each embedded object can have its own optional tool bar or menu bar.

Templates are comprised of files using the Extensible Stylesheet Language (XSL). Specifically they make extensive use of the transformations or XSLT portion of the specification. A skin 410 is maintained in one or more cascading style sheets (CSS) along with the corresponding images, fonts, audio, and other resources used in presentation of the page. The XSL files control the transformation of the XML data into XHTML output documents. The skin then defines the positioning, fonts, backgrounds and other elements of style used in presenting the components of the page to the user. The entire approach allows for the separation of data from presentation, and the ability to dynamically change this presentation.

Different skins change the layout of the page and the location of where objects appear in the page. For example, for a journal package, one skin could display a title and date at the top of the page and the format menu in the bottom right hand corner, and this would represent the default skin. By changing to a different skin, a user can move the title and date to the bottom and have the main editor piece for a format menu at the top. Furthermore, the user could change the layout and also different font sizes and imagery and backgrounds to be used within the page through the skin option.

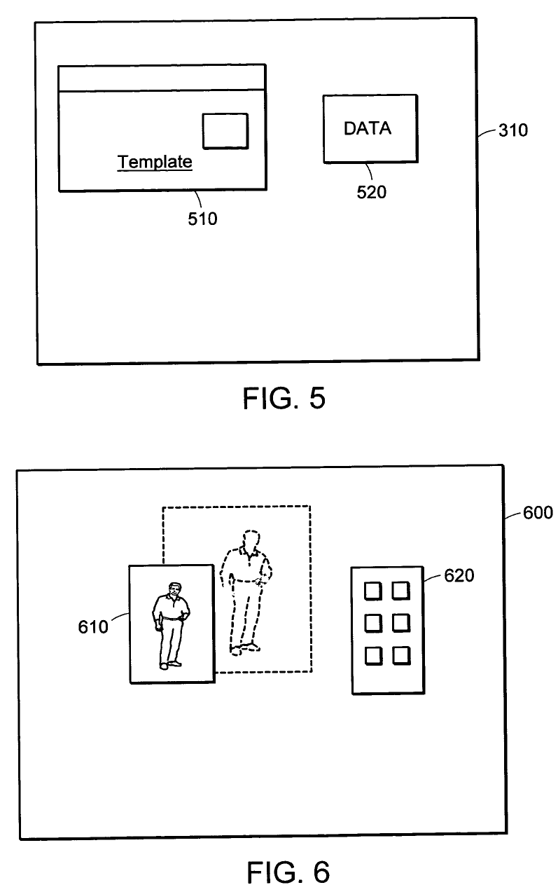

Referring to FIG. 5, page 310 is shown with the individual components that are used to create the page, namely a skin 510 and data file 520 (preferably in XML). Skin 510 in one embodiment uses Extensible Stylesheet Language Transformation (XSLT) as a processing specification. An XML parser is used to read XML data and XSLT rules. An XSLT processor then transforms the XML data using those rules, in this case into an output document based on the XHTML 1.0 standard.

With respect to the concepts of model view and control, the XSL template represents the view piece. Skin 510 specifies what colors to use, what images to use, and what fonts to use within the page. Data file 520 is preferably stored within an XML file. Any changes that are made in the user interface by the user are stored in data file 520. For example, in a scrapbook, when a scrapbook page is saved, the information is stored in data file 520. Data file 520 contains format information about the pictures, text, and music that have been added to the page. Data file 520 gets fed into skin 510 to produce the page as an output.

Referring to FIG. 6, in one example, starting with a blank page 600, a user selects an “Add Picture” option from the Page toolbar, and selects an image file to import. Attributes of the image (file path, width, height, etc.) are saved to the XML data representing the page 600. The XSL transform is then run on the page, causing an embedded Java object, an image panel object 620, to be created and displayed on page 600. Image panel object 620 has several operations that manipulate the on-screen image, such as rotate, scale, and resize.

Packages can be downloaded in ZIP or JAR format and can be installed in a Java Network Launch Protocol (JNLP) environment. The uncompressed files are visible in the keeper's table of contents as hyperlinks. When a user selects one of these hyperlinks, the program framework creates a new instance of the package and instantiates it. The program framework queries the package for a page, such as a cover page. The package returns the query with an XML file that represents the requested page.

Within every page or XML file, the contents denote what template is going to be used or what XSL is going to be used to display the contents of the file. The program framework parses the XML file for the name of the template (i.e. XSL file) and runs what is called an XSLT transform. The result of the transform is an HTML page.

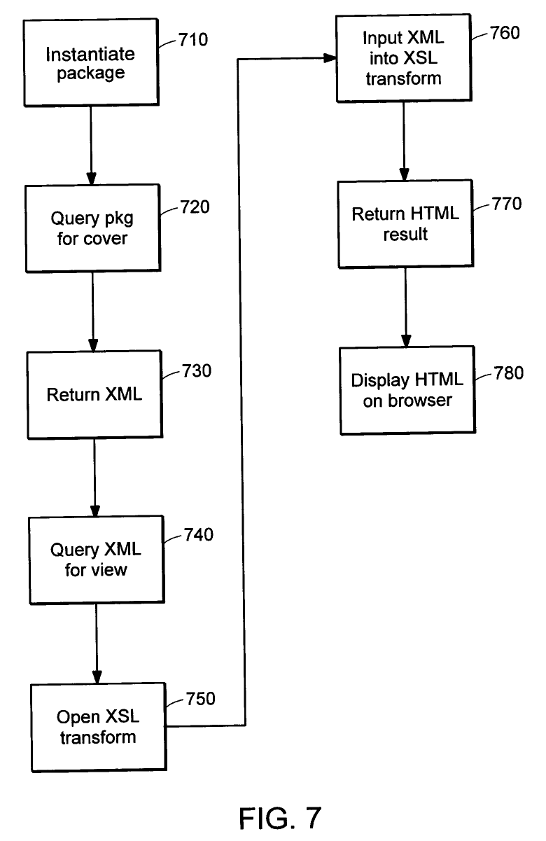

Referring to FIG. 7, the program framework instantiates a package (710) when the user clicks on the link to the package in the table of contents 140 (FIG. 1) and then queries the package for a page, such as a cover page (720). The package returns an XML data file (730). The program framework then reviews the XML data file for its view (740) and opens an XSLT transform (750). The XML data file is inputted into the XSLT transform (760), and returns a result of an HTML page (770) that is displayed in the browser (780).

In one embodiment of the invention, each package has its own browser panel in which the browser panel displays the HTML pages associated with the respective package. When the HTML is displayed within the browser, it will have the properties that were defined in the XSL template. For example, the background colors and entire layout of the page is a direct result of the XSL template. Each of the embedded objects found within a page have a tag (referred to as an object tag) that is placed in the XSL. When the HTML page is loaded, the embedded object tags are then instantiated and create the embedded object.

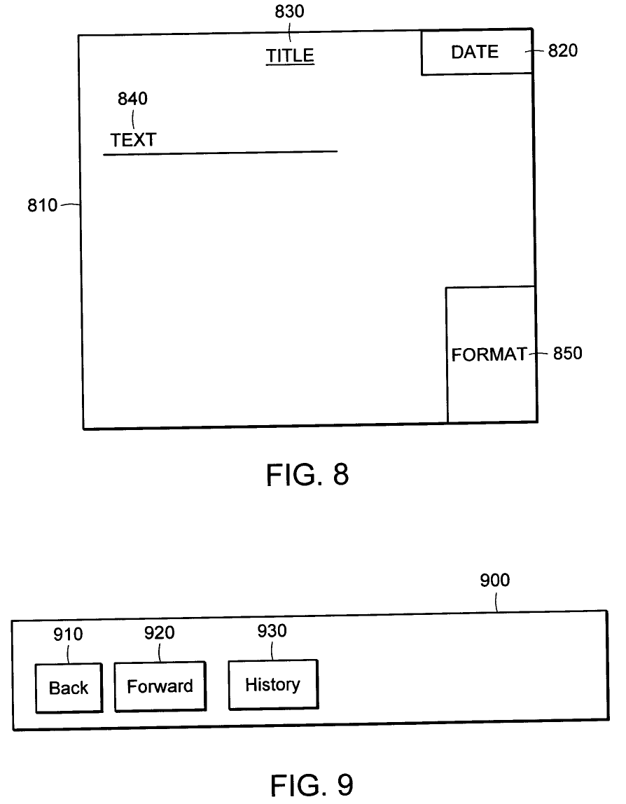

In an example of a journal 120 (FIG. 1), once a page is visible to the user as described above, FIG. 8 illustrates an embodiment depicting one page 810 from journal 120. Journal page 810 has a date field 820, a title field 830, a text field 840, and a format menu 850. In one embodiment, date field 820 can either be filled out by the user, or the program framework can by default fill this in for the user using the computer's date. Title 830 represents the user-entered title of journal page 810. The text within title 830 can be formatted using format menu 850. Similarly, text field 840 has text to be entered into journal page 810 and can be formatted using format menu 850. Examples of the functionality of the format menu 850 include bolding, underlining, changing colors, changing font size, etc., functions that are generally know and familiar from word processing.

In another embodiment, data is automatically cached, for example, in a reserved section of main memory or an independent high-speed storage device. Newly changed data can be copied from the page to its parent section page. Which data elements are copied is defined by a set of rules in the parent page. This copying will be performed recursively for each page, i.e., if the parent has a parent, it also gets updated.

The page can be automatically saved periodically, e.g., every 30-60 seconds. The auto-save feature used here is different from typical auto-save functions in that the system determines if any embedded objects on the currently displayed page have been modified (as determined by the program framework) and auto-saves the page only if something has been modified. As well as occurring on a timed interval, auto-save also occurs upon navigation to another page in the package. The program framework saves only the data that has been changed. This auto save-option is seamless to the user.

As with other packages, the pages could be created in a more conventional manner with a large “journal maker” program. In a preferred embodiment of the invention, however, a keeper program with elements common to different types of packages can be obtained, and then one or more pages of journal packages can be purchased or licensed separately through a host web site. The pages can be small in terms of memory size because they have a limited and defined functionality. The pages can be obtained individually or in blocks, such as blocks of 25, 50, or 100 journal pages. One advantage of this approach is that users pay for only what they need. For example, if they only need 20 pages, they are essentially only paying for 20 pages. Another approach, which is more conventional, is to charge a one time fee and allow unlimited use for a single user.

Referring to FIG. 9, the system allows a user to navigate among the user's pages. An exemplary navigation tool bar 900 includes a back button 910, a forward button 920, and a history button 930. The back and forward buttons 910 and 920 are used to navigate through the pages of the package. The history button 930 is used to navigate back to pages previously referenced.

One feature is the ability to retain the state upon closing the package. When the user closes the package and then opens it up, the state is returned to the page it was on when the user last closed the package. This is accomplished in the following manner. Each package has a Preferences XML file that is saved when the package is exited. One of the elements saved in the Preferences file is a unique identification (ID) of the last page visited in the package. Upon package startup, the value of last page visited is read out of the Preferences file and displayed in the package.

The description so far has focused on the program framework and how packages are downloaded and how pages are created, and now turns to communications and sharing of the packages.

Packages can be shared in multiple ways. Three groups of ways as described below: person to person sharing, e.g., with instant messaging (IM), email, and/or WiFi; computer to computer sharing; and locker sharing.

In the case of person to person sharing, users can interact with other users and can find it useful to extend that interaction to the user's work, including the user's creations. For example, a user can create an electronic scrapbook, and then share the scrapbook with friends as the user would with a conventional paper scrapbook. For person to person sharing, such sharing can be done in a manner consistent with what the user tends to do with a piece of paper or a book, i.e., share it with another person quickly and easily.

For computer to computer sharing, interoperable software can run on multiple computing devices, e.g., a PDA and a home computer, and the user may want to have the same information on two or more of the computing devices so that the user does not need to switch from system to system to find information. In addition, computer to computer sharing can be used as a backup system. For example, if one of the computing devices is stolen or breaks, the user's data is still available on the other computing devices.

Locker sharing is another method, and one that provides a backup capability. If the user has important data that the user needs to back up, the user can cause the data to be sent from a computing device to a storage location, referred to here as a locker, and can later retrieve the data from the locker to restore the data to the same or a different computing device. In at least some implementations, the locker may serve as a group locker that can be accessed by multiple users at their own convenience. The locker can be maintained by an Internet service provider at a remote server location.

Users can share any subset of a package (such as one or more sections or one or more pages), as the system allows for sharing arbitrary subsets of a package. Although in the cases of computer-to-computer sharing or locker sharing, the user is likely to share the entire package, sharing a section is useful in computer-to-computer or locker sharing in the event that the section is large, e.g., it includes many pages or many embedded objects. In particular, photographs taken with a digital camera and MP3 audio files can consume significant memory space; consequently, it might not be feasible to send an entire package to a locker or other computer.

To initiate a sharing instance, the user can interact with a dialog box of the keeper program. The user presses a share button (typically on screen), the dialog box comes up, and the user is given an option of sharing the entire package or a currently selected section or page (the section or page within which the user is currently operating).

In one implementation of person to person sharing, the first and second computing devices each run the keeper program to access and manage packages such as a scrapbook, journal, or photo album. In addition, the first and second computing devices are also configured to use an instant messaging (IM) account, e.g., via America Online or Yahoo.com, and to access a web server.

When the user of the first computing device (“sender”) decides to send the scrapbook to the user of the second computing device (“recipient”), the sender selects a share button in the keeper program and selects the recipient from a list that may have been previously built by the sender and maintained by the sender's keeper. Selecting the share button causes a message to be sent over to the recipient. A similar embodiment can be implemented using a local (peer to peer) chat when both keepers are on the same subnet wherein user authorization and communication is provided by the program framework's own peer to peer communication system.

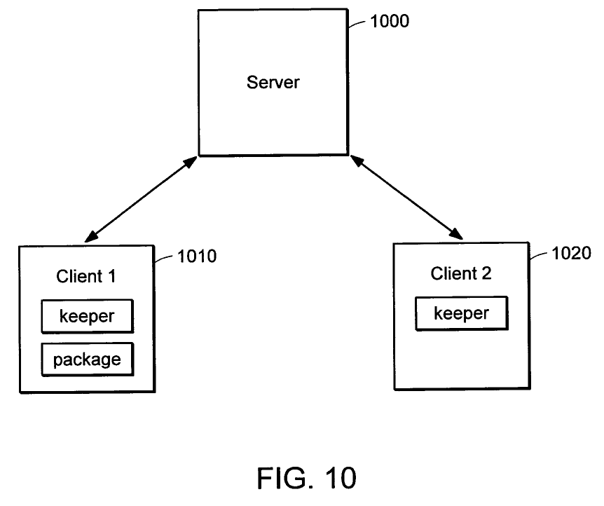

FIG. 10 is a block diagram of one embodiment showing a server 1000, a sender client 1010 and a recipient client 1020. Within the present embodiment, client 1010 has the ability, through the program framework, to share one or more pages and/or packages with client 1020. Conversely, client 1020 maintains this same ability through its own program framework application.

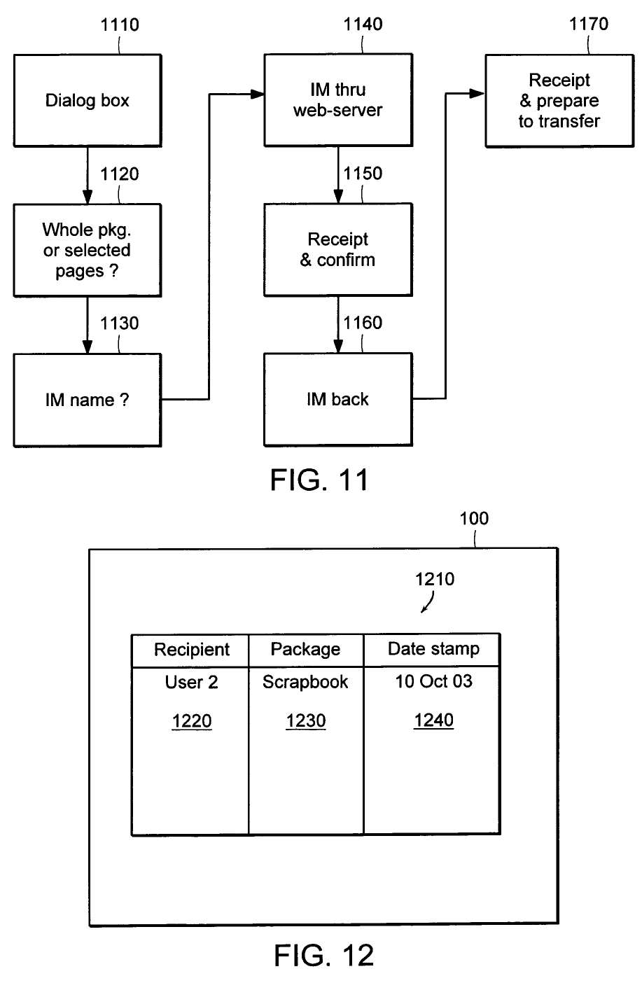

FIG. 11 is a flow chart illustrating the process by which a first user associated with client 1010 shares a package or pages from a package with a second user who is associated with client 1020. The first user interacts with a dialog box (1110) to initiate a sharing instance. The user presses a share button and a dialog box is shown on the first user's user interface screen. The dialog box asks the first user whether the user would like to share the whole package or selected pages (1120). After that selection, the user is prompted to input the instant message name of the recipient (1130).

The instant message (IM) is communicated through an IM server (1140). Upon receipt of the IM, the recipient confirms the authorization to share the specified pages and/or package (1150). If the second user associated with the second client authorizes this sharing function, a subsequent IM is sent back to the sender or first user through the IM server (1160). Upon receipt of the IM confirmation back to the first user, the program framework then prepares the pages and/or packages for transfer.

IM's are also used to send “control” messages between the systems. The control messages are effectively commands embedded in HTML comments that are sent as a normal IM message. These commands are intercepted and interpreted. The sending system adds a request ID to the first control message. A request ID uniquely identifies the file request. The request ID is used by the sending and receiving systems to prevent unauthorized file receptions by matching incoming files to the request ID. The request ID is included in all subsequent control messages from both the sender and the recipient for the duration of the sharing operation. This process thus functions as an interprocess communication over IM.

Email could alternatively be used to send control messages, but IM is much more immediate, which is beneficial to application responsiveness. Furthermore, IM has lower overhead than email.

FIG. 12 illustrates an embodiment of the sharing feature. The keeper 100 (FIG. 1) maintains a list or directory 1210 that is used to control what data is sent to other users. A list 1210 can include three sets of information (shown here in representative form as columns on a display): recipient column 1220, package column 1230, and date or time stamp column 1240. The granularity of this time stamp is accurate to within the order of milliseconds. The recipient column 1220 has a list of users that the owner of the program framework 100 has sent previously one or more pages and/or a package. The instant message name of all previous recipients is used to identify each user. Package column 1230 identifies which package has been sent to the recipient, and date stamp column 1240 indicates when the package was sent.

In the example depicted in FIG. 12, the owner of the system has previously sent the scrapbook package identified (package ID) within the package column 1230 to the recipient user located within recipient column 1220 on a date shown in date stamp column 1240. The program framework 100 determines which pages of the package have already been sent and received. The pages that have been added or changed since the last package sending are then prepared to be sent to that user.

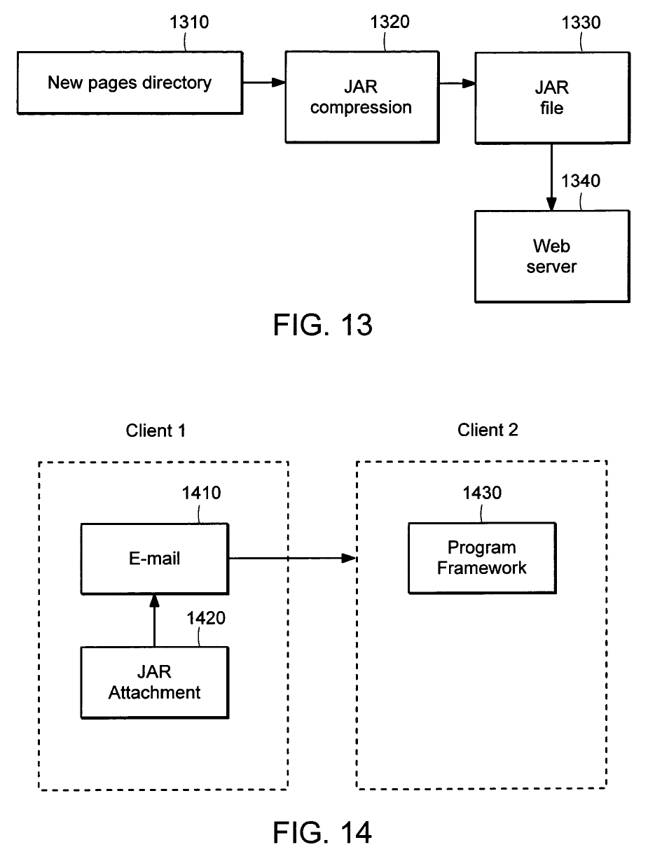

FIG. 13 is a flow chart illustrating the mechanics of preparing the new pages to be sent to the recipient by the program framework. A list of files from the package 1310 are handed to a JAR compressor 1320. JAR (short for Java archive) is a file format to bundle all components required by a Java applet. JAR files simplify the downloading of applets since all the components (class files, images, sounds, etc.) can be packaged into a single file. JAR supports data compression which further decreases file size. A JAR file can also have a manifest with metadata about the data in the JAR file. As shown in FIG. 13, the result of the JAR compression 1320 is a JAR file 1330 which is now ready for upload through a web server.

JAR file 1330 is transferred to a web server 1340 using the known Web-based Distributed Authoring and Versioning (WebDAV) protocol, although other pluggable transfer implementations are supported, such as FTP and SOAP. WebDAV is an IETF standard set of platform-independent extensions to HTTP that allows users to collaboratively edit and manage files on remote Web servers. WebDAV features XML properties on metadata, locking (which prevents authors from overwriting each other's changes), namespace manipulation, and remote file management.

After uploading the JAR file 1330 to the WebDAV web server 1340, the sender sends a link to the WebDAV server to the intended recipient. The recipient's application receives the link to the WebDAV server and automatically downloads JAR file 1330 from web server 1340. The recipient system copies the changed files from the JAR file 1330 into the local system. The new pages are then integrated into the recipient's package. Optionally, a confirmation can be sent back to the sender. Column 1240 describes a single timestamp—the time the package was last sent. The JAR manifest contains the last modification time of each file that is being sent. The recipient's system uses the timestamps in the manifest to compare files. Those timestamps contribute to making sharing work.

JAR compression as indicated in 1320 of FIG. 13 can be performed by a Java API. Each individual byte of the new pages are fed into the JAR software. The JAR software API requires a stream of bytes. Found within the manifest of the JAR file 1330 is also the package ID of the package which is compressed in a JAR file. Package ID is used to uniquely identify a package. In one embodiment, package ID is used to prevent the confusion between scrapbooks of two different owners. In a similar manner, pages are assigned unique numeric identifiers. The package ID of the sender's package is unique such that one user's scrapbook will not have the same package ID number as another user's scrapbook package ID.

The manifest is also used to transmit a flag value that indicates whether or not the compressed file contains the entire package. In other words, the flag denotes whether all the compiled code, the templates, and the user/data are present in the compressed file. The manifest also contains the senders name and/or IM identifier.

In addition, the manifest is used to maintain and convey the sequence number which is part of the file of 1210. The sequence number is the number of times the sender has sent the package to the recipient. So if a sender has sent a scrapbook to the recipient on four different occasions, the sequence number would be four. Furthermore, the recipient will also maintain its own list by which to track sequence numbers that they are expecting to receive. If upon receipt of JAR file 1330 to the recipient, there is a conflict of sequence numbers, an overriding correction process occurs which will now be described.

The recipient sends a message back to the sender denoting a conflict of sequence numbers and requests that the sender send the entire package. In a similar process according to FIG. 13, the send compresses the entire package into a JAR file and uploads this package JAR file to a web server. In a manner similar to the previous embodiment, the recipient downloads the package JAR file and installs the entire package onto the recipient's program framework.

As a precaution, the first steps that the recipient performs are an error-checking protocol and then a review of the manifest to confirm that the package is not only both the same package as requested, but also receives the authorization to do so. The recipient checks to see if the compressed file was expected or not.

For installation, the package files are separated into their respective component parts. The expanded package files are handed off to a launching mechanism built into the program framework. The launching mechanism takes the information from the unpacked package and installs the program pack on the recipient's system.

Pages added to an installed package are linked in the appropriately designate section. Hyperlinks are added to correspond to the new page in order for proper package navigation. In the event that the hyperlinks are destroyed, synchronization of the new pages is not performed. Instead, a change log is maintained which is a list of events that the user performed on the page.

In another embodiment of the invention, a conflict resolution method is implemented using a resolution algorithm. A conflict occurs when both the sender and recipient have changed pages since the last sending of the package pages. If a conflict resolution is required, the recipient's system will overwrite the recipient's changed pages in favor of the sender's new pages contained within the JAR file 1330.

In yet another embodiment, the resolution algorithm supports multiple conflict resolution strategies. For example, the sender's file can overwrite the recipient's, the sender's file can be thrown away, data from the two files can be merged (section files only, not valid for pages or embedded objects) or the package owner's file can “win” and overwrite the recipient's files. Resolution strategies can be conditioned upon different file-by-file bases.

FIG. 14 shows a block diagram representing an alternative embodiment of the invention in which IM confirmation and web server uploading is circumvented. In this embodiment, the first user (sender) simply emails a JAR attachment 1420 to a program framework 1430. The program framework 1430 applies the changes in a similar manner according to the previous embodiment by comparing date stamps, determining if there is a conflict, and replacing the data of the new pages into the package of the recipient's directory.

Another embodiment includes the use of a IM/email hybrid. In addition to the IM serving to communicate permissions and authorized requests, it also can be used to communicate “control” messages as previously described. The email takes the place of the web server and can attach all file components, compressed or otherwise.

In another embodiment, the program framework includes an implemented local IM protocol. The local IM protocol is a direct peer-to-peer IM system which does not require a third party server. The advantage of this embodiment is if this is implemented on a private network, there is no overhead of a web server such that files can be sent directly peer-to-peer. A mini-webserver runs alongside the IM protocol.

Another embodiment includes an implementation of WiFi on a private 802.11 network, using 2.4 gigahertz carrier frequency to transfer information from a mobile device to the network. In the present WiFi embodiment, a user who owns both a computer and mobile device can maintain a locker which is to be synchronized automatically whenever the mobile device can be seen by the network through the WiFi network.

In another embodiment contained within the WiFi embodiment, the mobile device can update information stored in the personal information manager (PIM) back and forth from the client computer and the mobile device. This update can be seamless in time to the user.

Lockers can be used as a backup system on a public network. Two computers that are able to see each other on a network can be set up and implemented to perform a computer-to-computer sharing type of system. When a locker is created on one of the client computers, the other client computer can be periodically updated and vice versa. The locker merely is a depository and may be used to restore a copy of a program or a package that was deleted in order to revert to a previous date if necessary. The program framework can push files up into a locker and download them at a later time. The web server on which the locker resides does not execute or open these pushed files.

Lockers are web servers that do not run any of the program framework's code. A difference in lockers described here is that the lockers can be run by third-party providers or ISPs. A user would purchase storage space on the locker and use the locker upload/backup feature to share with the locker. When storing files in a locker, only the client system needs to be running the program framework. The server can be a WebDAV, FTP, HTTP, etc server.

The inventions described herein include a number of systems and methods, including, without limitation, the downloading and creation of package, the method of providing consumable applications, i.e., providing pages as opposed to a large program for designing pages, collaboration using instant messaging, and the use of a transparent locker.

The keeper program works in conjunction with a browser and has a number of features that improve the ability to download and save information, and especially multimedia information. One feature makes it easier to save streaming audio that may be available from a website. A song or other audio clip may be available from a website. Selecting that audio causes a media player to open and the audio to be streamed to the user. A feature is added to allow the user to easily save audio while the user is listening to it. For example, if the user is listening to a song and decides that he or she wants to save that song, the user can select a feature while the music is playing, preferably through the use of a single mouse click or key stroke, to keep the song. The system in a manner that is preferably transparent to the user creates another instance of the browser and media player to access the song and to cause the streaming audio to be saved while the user is still listening to the streaming audio that had started previously. For example, a user is listening to a sing for two minutes and decides that he or she would like to save that song. The user elects to keep the song and selects the “keep close” option. If the song is four minutes long, the user will continue to be listing to the song for the next two minutes, while the background, all four minutes of the song are being accessed and stored into the system.

The storage process can be simplified for users by having different defaults selected for different types of media. For example, currently users are often faced with a choice of “open” or “save”, with the saving selecting a particular folder. The system can, however, have defaults that are not necessarily limited to just folders, but allow the user to automatically open or save in a desired location without going through the steps of selecting different options. The options can be different for audio-only versus audio/video versus other forms of multimedia.

Another features is a feature that allows a user to easily save web pages and portions of web pages. This feature, referred to as “clippings” feature allows a user to save a web page in its current state easily or to select text or graphic in a web page and select that in a quick and convenient manner. The toolbar can include a “keep page” button to make it easy for the user to save the page. In response to selection of “keep page”, a dialog box is presented for the user to select a location to save, and whether the use wants to keep the whole page or a portion of it, and the page is provided to the selected location. When provided onto a page, the kept web page or portion can be presented in a window with an adjustable size and with horizontal and/or vertical scroll bars.

Another feature involves the organization of media and particularly photographs. Photographs typically include metadata provided by a digital camera. This metadata can include a variety of pieces of information, including a date on which the photograph were taken. Typically, the photographs would be downloaded in some particular order based on date taken. The keeper program allows a user to enter important dates and date ranges, including fixed dates, such as birthdays or July 4, and also date ranges, such as a range of dates during a vacation or a range of dates over a holiday, such as December 20-29. The keeper program receives the metadata and can automatically organize the photos in files or on pages based on the date. This process makes it easier for the user to automatically keep photographs of a birthday, vacation, or other event together and simplifies the task of reviewing each photograph and saving it separately. Video or audio-video can be organized in a similar manner.

While certain methods and approaches have been described, many modifications can be made to the inventions as described in exemplary embodiments above.

1. A system comprising:
a plurality of different multimedia software packages, each package including program code for executing package processes, data files for holding content, and a template for presenting the content,
the data files, template, and program code being separated to allow one of the data files, template, and program code to be changed without changing the others of the data files, template, and program code;
a client program operable with each of the packages for managing common functions, including web browsing and instant messaging and/or email communications for use with sending a package.

2. The system of claim 1, wherein each package include a plurality of pages associated with content.

3. The system of claim 2, wherein the common functions of the client program include the ability to create, display, and navigate through pages.

4. The system of claim 1, wherein the packages include a scrapbook package having onscreen pages that show textual content, still and/or motion video content, and representations of audio content.

5. The system of claim 1, wherein a package imports an image file, saves attributes of the image file into a markup language data, which data is then transformed through the template for presentation.

6. The system of claim 1, wherein the client program has functionality to allow a package to be transmitted to another computer, the system further comprising a second system having the client program, and responsive to receiving a transmitted package for executing the program code and viewing the content from the data files with a presentation as determined by the template.

7. The system of claim 1, wherein the client program manages sharing of packages with other users with the client program.

8. The system of claim 7, wherein the sharing is done through a peer to peer network.

9. The system of claim 7, wherein the client program manages information regarding what packages were shared with other users.

10. The system of claim 1, wherein at least one package can receive digital photos from an external source, the digital photos including metadata including information about when the photos were taken, the system responsive to the metadata and to previously received dates for automatically organizing the photos based on the dates the photos were taken.

11. The system of claim 1, wherein the system is responsive to the downloading of different types of media for providing defaults, including whether to save or open the media, and where to store the media.

12. The system of claim 1, wherein the client program includes a browser, the system including a clipping functionality whereby the use can select all or a part of a web page accessed by the web browser and save directly into a page of a package.

13. The system of claim 1, wherein the system includes a browser that allows access to streaming audio and/or video media, and includes a user-selectable option to save the streaming media by opening a second browser instance while the media is streaming, and saving the media into a package.

14. The system of claim 13, wherein the second browser instance is opened in a manner that is not visible to the user.

15. The system of claim 1, wherein the packages include two or more of the following: a greeting card package for creating greeting cards, a journal, a music package for downloading and organizing audio, a photo album, and a scrapbook.

16. A method comprising:
receiving streaming media, including audio and/or video, through a first browser;
responsive to a user-selectable option to save a copy of the streaming media, opening a second browser while the first browser is streaming the media, and saving the streaming media at least partly while the first browser is still streaming.

17. The method of claim 16, wherein the opening and the saving are each done transparently to the user.

18. A method for managing digital video content comprising:
receiving multiple pieces of digital video content, including still and/or motion video, that includes timing data indicating a date of when the content was obtained;
automatically organizing at least some of the content by grouping the pieces of video content based on the timing data into at least two previously defined dates and/or date ranges.

19. The method of claim 18, wherein the video content includes photos from a digital camera.

20. A method for sharing multimedia content comprising:
from a first computer that includes a client program and at least one package that includes program code for executing functions, a user interface, and data files with multimedia content, transmitting the package over one of instant messaging and electronic mail to a second computer that includes the client program,
the second computer responsive to receiving the package for opening the package to present to a user the content with an appearance based on the user interface and for executing the program code.
